(19) United States
(12) Patent Application Publication
(10) Pub. No.: US 2011/0111088 A1
(43) Pub. Date: May 12, 2011

(54) Method for producing dough pieces which can be stored for a long period of time

(75) Inventor: Stephan Krapp, Kassel (DE)

(73) Assignee: KAMPS GMBH, Schwalmtal (DE)

(21) Appl. No.: 12/878,056

(22) Filed: Sep. 9, 2010

(30) Foreign Application Priority Data
Sep. 9, 2009 (EP) 09011531.2

(51) Int. Cl. A21D 15/02; A21D 8/04

(52) U.S. Cl. 426/18; 426/496

(57) ABSTRACT

Method for the production of dough pieces suitable for long-term storage in which the dough pieces are placed in a climate-controlled room, a relatively humidity of 100% is established, whereby water is atomized at a droplet size <10 μm; and the temperature of the room is lowered and the lowered temperature is maintained until the core temperature of the dough piece is below the specific freezing point of the dough piece.

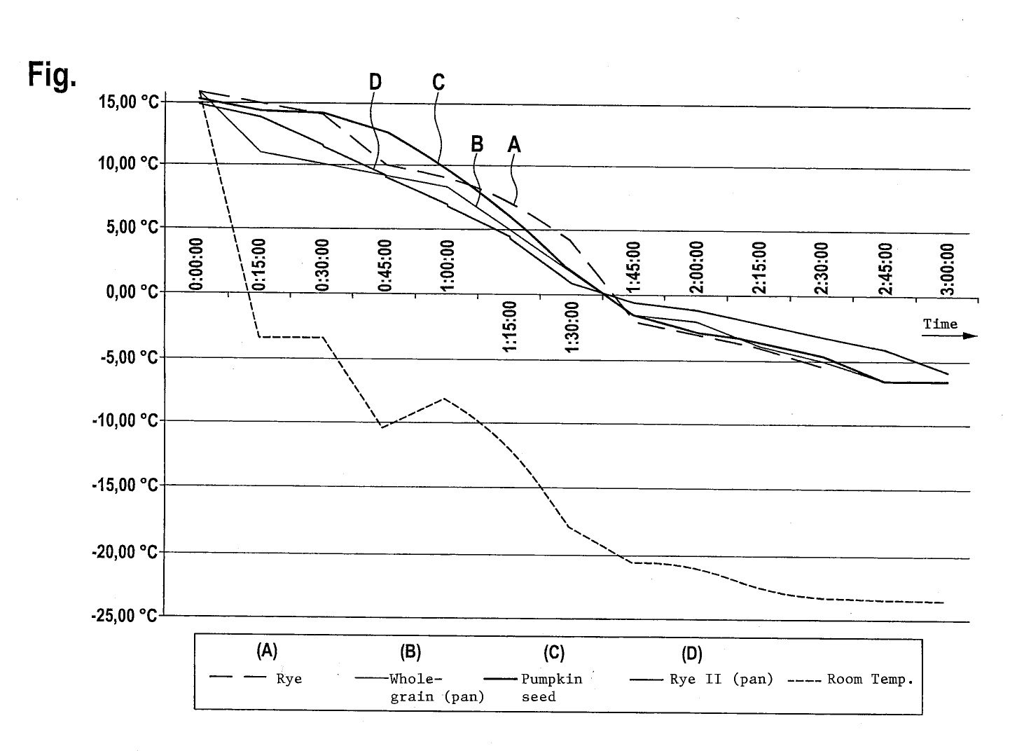

### BACKGROUND OF THE INVENTION

This invention relates to a method for producing dough pieces which can be stored for a long period of time.

Dough pieces of this type are in particular yeast dough pieces such as dough pieces for bread or croissants which can be raw, prebaked or at least half-baked, as well as pastry dough pieces.

“Which can be stored for a long period of time” means that the dough pieces must remain usable for at least eight weeks, preferably 12 weeks, without the appearance of any quality deficiencies in the finished baked product.

Frozen storage has proven to be successful with small dough pieces for pastry products and small baked goods. However, it has not been possible to store frozen dough pieces that weigh 500 g or more without major compromises in quality.

Controlled cooling thereby has a whole series of undeniable advantages for bakers who do the final baking locally. The production and baking times can be rendered independent of each other by the use of refrigeration, larger batches can be prepared and products that can be baked fresh on demand make it possible to optimally satisfy the most important of all customer wishes. These advantages are explained in greater detail below in the context of an examination of baking and logistics systems in current use.

The increasing cost and complexity of production are strengthening the position of pre-bake stations and bakery discounters that pre-bake industrially produced baked goods, so that the half-baked goods can be reheated in front of the customer. These breads are baked until they are almost finished and need to be baked again locally only until they are browned. The availability of hot baked goods gives the illusion of freshness and hand-made products. The result, however, is baked goods that can be sold cheaply only at the expense of quality. The repeated baking of baked goods results in, among other things, an enormous loss of moisture which leaves the products dried out. The alternative, which is to bake the products in a central bakery and then ship them, results in a solution where the baked goods are not always available where and when they may be needed and also suffer a noticeable loss in quality after only a few hours.

The product quality can be significantly improved and continuously ensured by a precise monitoring and control of all of the important parameters in the climate-control process, even with very large quantities of product. In the interest of producing high-quality baked goods, the moisture content and the movement of the air must be monitored and controlled, in addition to the temperature and time, during the cooling, frosting and thawing. Time is a particularly critical variable during cooling and even more during frosting.

If a dough piece is cooled to temperatures for frozen storage, i.e. below −18° C., the process normally consists of three phases of cooling, in which entirely different amounts of energy are required to continue the cooling process. The physics of the freezing process are described, for example, in the article entitled “Bäckerkälte: Das richtige Klima macht die Qualität [Freezing for bakers: The right conditions ensure quality”] at http:/www.webbaecker.de/r-branche/2003/0303profikaelte.htm.

In a first cooling phase, the dough piece is cooled from room temperature to just above the specific freezing point of the dough piece. With doughs that contain fats, salts, minerals and other ingredients in addition to water, the freezing point is lower than that of pure water, namely approximately −7° C. In the remainder of this application, this temperature is designated the specific freezing point of the dough piece. Approximately 35% of the total cooling energy is used for this first phase.

The phase transition of the water bound in the dough piece from liquid to solid takes place in the second cooling phase and consumes a proportion of approximately 55% of the total cooling energy. The more rapidly the dough piece is cooled and in particular chilled all the way through in this phase, the better the baked result. “Shock freezing” ensures a particularly fine crystal structure in the baked good, without thereby destroying enzymes and the structure. While that does not represent a problem with small dough pieces, shock freezing generally is not successful with large-volume bread dough pieces because it later leads to an unsatisfactory baked result.

Finally, in a third cooling phase, the dough pieces are cooled even further to the storage temperature. Only 10% of the total cooling energy required is used for this phase.

### SUMMARY OF THE INVENTION

The invention relates in particular to improvements in the first and second cooling phases. In spite of the relatively slight cooling of only a few degrees Celsius that takes place, these phases normally consume much more than half of the cooling energy required.

The object of the invention is therefore a method for the production of dough pieces that are suitable for long-term storage which ensures that the dough piece is rapidly cooled and which also ensures an effective chilling all the way through. That is important in particular when larger dough pieces, e.g. pieces of bread dough weighing more than 500 g, must be handled.

This object is accomplished by the method described in claim 1. The invention teaches that the dough pieces are placed in a climate-controlled room in which a relative humidity of 100% has been established, and into which water is atomized at a droplet size <10 μm. The temperature of the room is lowered and the lowered temperature is maintained until the core temperature of the dough piece is below the specific freezing point of the dough piece.

The use of a water fog with a droplet size <10 μm for the production of unfinished baked goods is known. For example, EP 1 941 800 A2 describes the essentially homogeneous moistening of the respective unfinished baked product all the way through by circulating air around the unfinished baked product, so that the micro-droplets of water penetrate into the respective unfinished baked product so that there is an essentially uniform and thorough moistening of the individual unfinished product all the way through. The aerosol is thereby produced by means of an ultrasound atomizer, whereby the high-purity water used has previously been freed of microorganisms, lime and salts in a reverse osmosis plant. The increase of the relative humidity by the technique described in this prior art document as ultrasound climate control takes place in a freezing phase at −18° C., which is followed by a storage phase at −10° C. and a thawing phase at +1 to 3° C. The aerosol ensures that there is moisture on the surface of the frozen product.

FR 2 852 205 A describes a method for the preparation of fermentable food products by circulating air which includes at least one storage phase of the products during the cooling, while cooled cold air is circulated, in particular to interrupt the fermentation of the products, and a phase for treatment with wetting/warming, in which warm and moist air is circulated. During this wetting/warming phase, the

circulating air is moistened with a moistening aerosol generated by an ultrasound generator.

The invention does not use the aerosol to establish a uniform moistening of the respective dough piece all the way through, which is already achieved during the preparatory steps of the production of the dough piece. It has in fact been found that no measurable quantity of moisture is absorbed from the aerosol atmosphere. On a bread dough piece weighing 1000 g, a moisture absorption of 3% would correspond to a measurable weight increase of 30 g, although no such weight increase has ever been observed.

It has been determined, however, that the presence of the aerosol significantly improves the hot-to-cold transition of the dough piece. This can be confirmed by conductivity measurements. The treatment times can thereby be significantly shortened. This method also eliminates problems that are normally involved with the condensation of moisture at falling temperatures.

Because the core temperature of the dough pieces is also used as a reference for the control of the temperature of the room, this method ensures that the dough piece is optimally frozen through.

In one advantageous development of the method claimed by the invention, the dough pieces are fermented for a predetermined length of time at a temperature of 15° C. to 20° C. before the room temperature is lowered. Fermentation at these relatively low temperatures ensures that for further cooling, the dough pieces do not need to be cooled from a comparatively high temperature of 32° C. to 35° C., as is conventional in the prior art, which ensures a significant energy saving. The reduced fermentation temperature of 15° C. to 20° C. combined with the extended fermentation period also has advantages in terms of quality, as explained in greater detail below.

It is further advantageous, during the lowering of the temperature of the room, to include at least one plateau phase during which the temperature is kept constant, and during which the aerosol is regenerated if necessary. The method claimed by the invention employs relatively low cooling rates employed which lie in the range of 0.26° C./min and 1.3° C./min.

A more rapid cooling is undesirable because it destroys the aerosol and would have a disadvantageous effect on the cooling process and on the quality of the dough piece.

### BRIEF DESCRIPTION OF THE DRAWING

The invention is explained in greater detail below with reference to the accompanying drawing. The FIGURE shows the curve of the core temperature for different bread dough pieces in reaction to the room temperature.

### DETAILED DESCRIPTION OF THE INVENTION

In the FIGURE, the line A represents the curve of the core temperature in a rye bread dough piece, line B the curve of the core temperature in a piece of whole-grain dough, the curve of the core temperature in a piece of pumpkin seed bread dough in the pan and D the curve of the core temperature in an additional piece of rye bread dough in the pan. The curve of the room temperature is indicated by the broken line.

For the production of a dough piece, the conventional ingredients and baking agents, a soaker and dry sourdough are prepared according to specified dough parameters to form a dough. After the dough has rested, the dough is conducted by means of a bowl tipper to the weighing machine. The dough pieces are weighed, shaped, allowed to fall into a coating or dusting mixture if necessary and placed on a baking sheet with or without parchment paper. The dough pieces are then moved on oven racks into a climate-controlled room. There they are first fermented for a specified period of time at a temperature of 15° C. (not shown in the FIGURE). The relative humidity in the climate-controlled room is thereby set to 100% by using an ultrasound atomizer to generate an aerosol of previously purified water in droplet form, whereby the droplets have a diameter of 10 μm or less. Measures which are themselves described in the prior art are employed during the entire process to ensure a constant and controllable circulation of the air at different speeds in the room. Contact with the aerosol droplets promotes the activity of both the yeast and the enzymes, as a result of which lower fermentation temperatures in the range of approximately 15° C. to 20° C. are possible. These lower fermentation temperatures allow the flour ingredients of the dough piece to swell, in particular if the fermentation is continued for a longer period, as a result of which aroma and flavors develop. It has been shown that with this method, the shelf life and stability of the dough piece are improved, which contributes to preserving quality during cooling, freezing and thawing.

Then the dough piece is cooled in a first cooling phase to −4° C. over a period of 15 minutes. This temperature lies above the specific freezing point of the dough piece which is assumed to be −7° C. for each point in the dough piece. First there is a superficial cooling of the dough, followed by a cooling of the core temperature. That is followed by a 15-minute plateau phase at −4° C., during which the relative humidity is adjusted as necessary and the aerosol is regenerated. Then the dough piece is cooled for an additional 15 minutes to approximately −10° C., at which point the cooling equipment is turned off. The goal is to stop the activity of the yeast, which occurs at approximately +6° C. Otherwise there is a risk that the yeast in the core of the dough piece will continue to ferment, which leads to cracks in the surface.

A rapid cooling is disadvantageous in the method claimed by the invention because it destroys the aerosol. If necessary, in addition to the above mentioned plateau phase, additional phases with a constant temperature can be added for the regeneration of the aerosol.

During the adjustment of the aerosol, the tolerance until the equipment is turned back on is approximately 1.5° C., which explains the rise in the room temperature until the end of the cooling time, which is approximately 1 h.

Only when the core temperature of the dough piece has reached +6° C., i.e. 65 to 95 minutes after the beginning of the cooling, depending on the type of dough piece, the cooling equipment can be turned on full. After the room temperature has been lowered further, it is maintained between −20° C. and −25° C. until the core temperature reaches −7° C. That is the case after approximately 2 hours and 30 minutes for a rye bread dough piece, approximately 2 hours and 45 minutes for a whole-grain bread dough piece and a pumpkin seed bread dough piece in a pan and approximately 3 hours for the additional rye bread dough piece in a pan. Because with the dough pieces that are in a pan, the moisture can act over only a small surface area, it takes somewhat longer to reach the desired core temperature in those cases. The rye bread dough piece is also relatively heavy, as a result of which a longer treatment time is observed.

The dough pieces prepared in this manner can then be deep-frozen and packaged, e.g. in polyethylene bags, and stored centrally in a freezer. The frozen bread doughs are then delivered via an appropriate logistics system to bakeries, where they are initially stored locally in the deep freezer. The dough pieces can then be removed from the freezer as needed, thawed according to specified parameters and baked according to the appropriate baking procedure. In this manner, fresh breads are constantly available in the bakeries as required.

Using the method claimed by the invention, a spatial separation is achieved between the location in which the dough pieces are produced and the site in which they are baked, which results in perceptible quality advantages. The method claimed by the invention also makes it possible to ship a reduced basic selection in the form of frozen dough pieces and to transform them locally into a large, attractive selection of baked goods. Baked goods are no longer baked centrally and need no longer be delivered fresh-baked daily, an operation which is both expensive and time consuming.

1. A method for producing dough pieces which can be stored for a long period of time, in which:
a) the dough pieces are placed in a climate-controlled room,
b) a relative humidity of 100% is established, by producing a water aerosol with a droplet size <10 μm; and
c) the temperature of the room is lowered and the reduced temperature is maintained until the core temperature of the dough piece is below the specific freezing point of the dough piece.

2. Method as recited in claim 1, in which the dough pieces are fermented before step c) at a temperature of 15° C. to 20° C. for a specified period of time.

3. Method as recited in claim 1, in which at least one plateau phase is maintained at a constant temperature during step c), during which the aerosol is regenerated.

4. Method as recited in claim 2, in which at least one plateau phase is maintained at a constant temperature during step c), during which the aerosol is regenerated.

5. Method as recited in claim 1, in which the temperature of the room is lowered at a rate in the range of 0.26° C./minute to 1.30° C./minute.

6. Method as recited in claim 2, in which the temperature of the room is lowered at a rate in the range of 0.26° C./minute to 1.30° C./minute.

7. Method as recited in claim 3, in which the temperature of the room is lowered at a rate in the range of 0.26° C./minute to 1.30° C./minute.

8. Method as recited in claim 4, in which the temperature of the room is lowered at a rate in the range of 0.26° C./minute to 1.30° C./minute.
